(19) United States
(12) Patent Application Publication
(10) Pub. No.: US 2016/0265413 A1
(43) Pub. Date: Sep. 15, 2016

(54) METHOD AND DEVICE FOR MONITORING A PARTICULATE FILTER

(71) Applicant: ROBERT BOSCH GMBH, Stuttgart (DE)

(72) Inventors: Markus Willimowski, Freiberg A.N. (DE); Enno Baars, Leonberg (DE); Torsten Handler, Stuttgart (DE); Klaus Winkler, Rutesheim (DE); Thomas Zein, Sindelfingen (DE)

(21) Appl. No.: 15/031,000

(22) PCT Filed: Oct. 17, 2014
(86) PCT No.: PCT/EP2014/072368

§ 371 Date: Apr. 21, 2016

(30) Foreign Application Priority Data
Oct. 24, 2013 (DE) 10 2013 221 598.3

(51) Int. Cl. F01N 11/00; G01K 13/02; G01M 15/10

(52) U.S. Cl. CPC F01N 11/005; G01M 15/102; G01K 13/02; F01N 2550/04; F01N 2560/06

(57) ABSTRACT

A method for monitoring a particulate filter in the exhaust duct of an internal combustion engine operated with gasoline, as a device for implementing the method are described. A first exhaust-gas temperature is determined upstream of the particulate filter and a second exhaust-gas temperature is determined downstream from the particulate filter, and a presence and/or a correct functioning of the particulate filter is inferred from a difference between the first and the second exhaust-gas temperature or from a differing time characteristic curve of the first and the second exhaust-gas temperature.

### BACKGROUND INFORMATION

The present invention relates to a method for monitoring a particulate filter in the exhaust duct of an internal combustion engine operated with gasoline.

The present invention furthermore relates to a device for monitoring a particulate filter in an exhaust duct of an internal combustion engine operated with gasoline, a control unit being assigned to the internal combustion engine.

A particulate filter in the exhaust duct of gasoline-operated internal combustion engine is used to reduce the particulates emitted by the internal combustion engine. As in a particulate filter for an internal combustion engine operated with diesel fuel, it is also necessary in the case of an internal combustion engine operated with gasoline to regenerate the particulate filter when needed by burning off the particulates. This regeneration must be monitored. Furthermore, regulations provide for the correct functioning and the presence of the particulate filter to be monitored during operation by way of diagnostic functions. The monitoring of particulate filters for diesel engines is performed via a determination of the pressure difference upstream and downstream from the particulate filter as well as via particulate sensors located in the exhaust duct downstream from the particulate filter.

German Patent Application No. DE 112008003421T5 described a method for regenerating a particulate filter, including:
providing an oxidation catalytic converter downstream from an internal combustion engine and upstream of the particulate filter,
providing a first oxygen sensor upstream of the oxidation catalytic converter;
providing a second oxygen sensor downstream from the oxidation catalytic converter; providing a processor for selecting an maintaining a desired change of the oxygen concentration above the oxidation catalytic converter for a selected period of time in order to provide an exhaust-gas flow discharged from the oxidation catalytic converter that has a setpoint temperature, and optional temperature detection, in order to provide an additional control loop;
regenerating the particulate filter by conducting the exhaust-gas flow discharged from the oxidation catalytic converter through the particulate filter, the temperature of the exhaust-gas flow flowing through the particulate filter and the selected time period being sufficient for regenerating the particulate filter.

German Patent Application No. DE102010046747A1 describes a method for carrying out a regeneration of a particulate filter of a spark ignition engine having an exhaust system that includes the particulate filter, a pollutant limiting device positioned upstream of the particulate filter, a temperature sensor designed to indicate a temperature of the particulate filter, and an oxygen sensor positioned downstream from the particulate filter. It provides for raising a temperature of the particulate filter during the regeneration; for introducing secondary air to a location downstream from the pollutant limitation device and upstream of the particulate filter in response to the temperature of the particulate filter being higher than a temperature threshold value and a time, in which a lambda of the oxygen sensor located downstream being preloaded to be rich; and for setting a particulate filter degradation condition in response to the temperature of the particulate filter being higher than the temperature threshold value and the time, in which the lambda of the oxygen sensor located downstream being preloaded to be rich, not being greater than a time threshold value.

By monitoring the air/fuel ratio downstream from the particulate filter for changes in oscillations in the air/fuel ratio of the exhaust gas, it is possible to determine suitable conditions for a particulate filter regeneration. In particular, a reduction of the oscillations indicates an oxidation of soot in the particulate filter. If an increased oscillation of the air/fuel ratio of the exhaust gas downstream from the particulate filter indicates that the soot load was oxidized, then the regeneration may be terminated. Lambda sensors are required in the claimed method. In this design, no temperature sensor connected downstream from the particulate filter is used.

German Patent Application No. DE102012207717A1 describes a method for regenerating a filter, which filters exhaust gas of an engine, the method including:
determining a soot accumulation in the filter;
comparing the soot accumulation to a first soot accumulation threshold;
and selective increasing of oxidation levels in the exhaust gas in response to the comparison between the soot accumulation and the first soot accumulation threshold in order to trigger a regeneration in the filter. The system shown in this connection in FIG. 1 includes a temperature sensor 180-3 connected downstream from the particulate filter. The description of the method according to FIG. 3, however, only describes controlling according to the particulate quantity, but not according to the temperature at temperature sensor 180-3. Temperatures are determined only in order to ensure a temperature that is suitable for starting the regeneration.

German Patent Application No. DE 10358195A1 provides a method for monitoring a component situated in an exhaust-gas region of an internal combustion engine in which the low-pass behavior, which is determined by the heat capacity of the component, is monitored by a valuation of a measure of a first exhaust-gas temperature (TvK), which appears upstream of the component that is to be monitored, and of a second exhaust gas temperature (TnK), which is detected by a second temperature sensor (TH) downstream from the component to be monitored. The method according to the invention makes it possible to monitor the component for a change which may have taken place, for example, during an inadmissible manipulation. In the extreme case, the component to be monitored, such as a catalytic converter and/or a particulate filter, may have been completely removed. The document teaches to infer a manipulation of a component from the behavior of the temperature of the exhaust gas flowing through the component resulting from the heat capacity of the component in an exhaust duct. A particulate filter, however, is not mentioned concretely.

German Patent Application No. DE 102009003091A1 monitors the presence of a sensor unit in that a sensor temperature is determined directly or indirectly by way of the sensor unit and from a comparison of the directly or indirectly determined sensor temperature with an exhaust-gas temperature determined by another sensor unit and/or with model variables and/or with defined threshold values, a detection of a removal and/or a functionally improper installation of the sensor unit is inferred. There is no provision for monitoring a particulate filter in that the temperature increase resulting by the exothermic reaction is used as a criterion.

In accordance with German Patent Application No. DE 102010002691A1, a particulate filter is diagnosed via a differential-pressure measurement, while there is no provision for an evaluation of temperatures upstream and downstream from the particulate filter.

German Patent No. DE 4426020A1 describes a method, in which the operativeness of a catalytic converter situated in the exhaust-gas region of an internal combustion engine is monitored. The monitoring is performed on the basis of the temperature increase generated by an exothermic reaction of the exhaust gases in the catalytic converter. Two temperature signals are ascertained, the first temperature signal being based on a measurement of the temperature downstream from the catalytic converter, and the second temperature signal being calculated with the aid of a model. In the case of a catalytic converter, but not in the case of a particulate filter, the document teaches to infer a correct functioning of a component from the exothermic reaction of the component—and the increased temperature thus produced by the component—occurring when it is functioning as intended. A diagnosis of a removed component is not mentioned.

It is therefore an objective of the present invention to provide a method for monitoring a particulate filter, particularly against its removal, for an internal combustion engine operated on gasoline.

It is a further object of the present invention to provide a device for implementing the method.

### SUMMARY

The objective of the present invention relating to the method may be achieved by determining a first exhaust-gas temperature upstream of the particulate filter and a second exhaust-gas temperature downstream from the particulate filter and inferring a presence and/or a correct functioning of the particulate filter from a difference between the first and the second exhaust-gas temperature or from a difference in the time characteristic curve between the first and the second exhaust-gas temperature. The example method is based on a detection of the effects of the thermal mass of the particulate filter or its influence on the temperature of the exhaust gas when burning off the soot particulates accumulated in the particulate filter. Consequently, the temperature characteristic curves upstream and downstream from the particulate filter display characteristic differences. If these do not occur, then the particulate filter was removed and replaced by a piece of pipe for example, whose thermal mass is considerably lower than that of the particulate filter.

One variant of the method provides for the first exhaust-gas temperature to be modeled from operating parameters of the internal combustion engine and for the second exhaust-gas temperature to be determined using a second temperature sensor or an exhaust-gas sensor having a temperature function. If the first exhaust-gas temperature upstream of the particulate filter is modeled from operating parameters of the internal combustion engine, a first temperature sensor may be omitted at this location. The design approach is thus cost-effective. The second exhaust-gas temperature downstream from the particulate filter, by contrast, must be determined by a second temperature sensor in order to detect the temperature characteristic curves that depend on the state of the particulate filter and to allow these to enter into the monitoring.

Normally, in a regeneration of the particulate filter, soot particulates are burned with oxygen from the exhaust gas. The quantity of soot deposited in the particulate filter may be estimated via a model on the basis of operating parameters or may be determined by a particulate sensor installed upstream of the particulate filter. To start the regeneration, a lean exhaust gas is introduced into the particulate filter at a sufficiently high temperature. The regeneration is an exothermic reaction and consequently heats up the exhaust gas additionally. It is possible to determine the released quantity of heat and thus the rise in temperature from the quantity of soot deposited in the particulate filter. The suitable temperature and exhaust-gas composition upstream of the particulate filter depend on whether a non-coated particulate filter or one having a catalytically active coating is used. The present invention may thus provide for a correctly installed and/or functioning particulate filter to be inferred during a regeneration of the particulate filter if the first exhaust-gas temperature in a specifiable period of time is lower than the second exhaust-gas temperature.

In this instance, the specifiable period of time is the period of time in which the exothermic reaction is expected.

The particulate filter has a considerably higher heat capacity compared to a piece of pipe of equal length and equal cross section. Hot exhaust gas entering a cold particulate filter therefore initially gives off heat and leaves the particulate filter in a cooled state until the particulate filter is sufficiently heated and the temperature at the outlet of the particulate filter rises. Likewise, cold exhaust gas entering a hot particulate filter will initially absorb heat and leave the particulate filter in a heated state until the particulate filter is sufficiently cooled and the temperature at the outlet of the particulate filter drops. For monitoring a particulate filter, it is thus suitable to infer a correctly installed particulate filter if the time characteristic curve of the second exhaust-gas temperature has a greater than a first specified time delay with respect to the time characteristic curve of the first exhaust-gas temperature.

The delaying effect of the particulate filter occurs particularly perceptibly in the event of a cold start of the internal combustion engine. The method of the present invention is thus suitable for inferring a correctly installed particulate filter if, following a cold start of the internal combustion engine, the time characteristic curve of the second exhaust-gas temperature has a greater than a second specified time delay with respect to the time characteristic curve of the first exhaust-gas temperature.

In addition to the delaying effect on the temperature characteristic curve, the heat capacity of the particulate filter also has the effect of reducing the amplitude of temperature fluctuations. This reduction depends on the duration of the fluctuation. The present invention provides for a correctly installed particulate filter to be inferred if the time characteristic curve of the second exhaust-gas temperature has an amplitude that is smaller at most by a specifiable factor than the time characteristic curve of the first exhaust-gas temperature. If the particulate filter is removed, then the connecting pipe has a lower thermal mass and reduces the amplitude of temperature fluctuations only negligibly.

An objective of the present invention with respect to the device may be achieved in that a second temperature sensor is situated in the exhaust duct downstream from the particulate filter and in that a circuit or a program sequence is provided in the control unit for determining a first exhaust-gas temperature upstream of the particulate filter and for detecting a second temperature using the second temperature sensor and for monitoring the particulate filter by an evaluation of the elevation and/or the time characteristic curve of the first and the second exhaust-gas temperature. The temperature and its characteristic curve upstream of the particulate filter may be determined with the aid of a model from the operating parameters of the internal combustion engine or by way of a first temperature sensor. The temperature and its characteristic curve downstream from the particulate filter are determined by way of a second temperature sensor. This second temperature sensor may also be embodied as an exhaust-gas sensor having a temperature function. It is possible to use a lambda probe by way of example, whose temperature is determined from the electrical resistance of a heater of the lambda probe or using a temperature sensor integrated into the lambda probe. This combination sensor may be used in a cold start prior to an end of the dew point for determining the temperature and for diagnosing the particulate filter and may be used as a lambda probe as soon as the end of the dew point is reached.

Below, the present invention is explained in greater detail with reference to an exemplary embodiment shown in the figures.

### BRIEF DESCRIPTION OF THE DRAWINGS

FIG. 1 shows the technical environment, in which the present invention may be applied.

FIG. 2 shows a first time characteristic of temperatures in the exhaust duct of an internal combustion engine.

FIG. 3 shows a second time characteristic of temperatures in a cold start of the internal combustion engine.

FIG. 4 shows a third time characteristic of temperatures in the exhaust duct of the internal combustion engine.

### DETAILED DESCRIPTION OF EXAMPLE EMBODIMENTS

FIG. 1 shows the technical environment in which the present invention may be applied. An internal combustion engine 10 operated with gasoline is supplied with combustion air via an air supply 11 and emits exhaust gas via an exhaust duct 14. A three-way catalytic converter 13 is situated in exhaust duct 14 downstream from internal combustion engine 10, behind which in the direction of flow of the exhaust gas a particulate filter 16 is situated. The temperature of the exhaust gas is determined upstream of particulate filter 16 by a first temperature sensor 15 and downstream from particulate filter 16 by a second temperature sensor 17. First temperature sensor 15 and second temperature sensor 17 are connected to a control unit 12, in which their signals are analyzed in order to monitor on this basis a presence of particulate filter 16 and its functioning. In another specific embodiment, it is possible to determine the temperature of the exhaust gas upstream of particulate filter 16 from operating parameters of internal combustion engine 10 and an associated model; it being possible then to omit first temperature sensor 15.

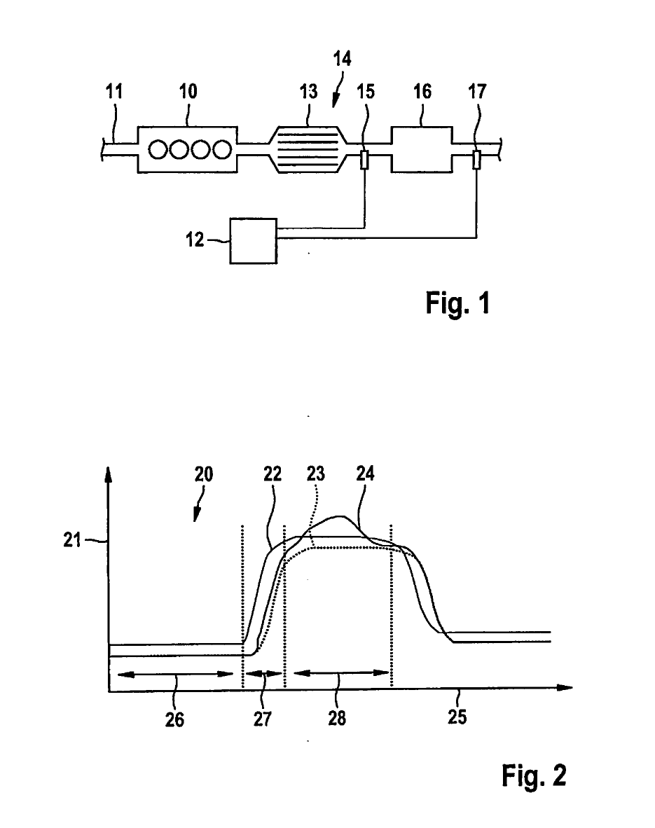

In a first temperature diagram 20, FIG. 2 shows temperature characteristic curves during a regeneration of particulate filter 16. The temperatures are plotted along a first temperature axis 21 and a first time axis 25. A first temperature characteristic curve 22 shows the time characteristic of the temperature upstream of particulate filter 16. In a first phase 26, particulate filter 16 collects soot particulates from the exhaust gas. For a regeneration, measures raising the exhaust-gas temperature are initiated in a second phase 27, and an oxygen surplus is set in the exhaust gas such that first temperature characteristic curve 22 rises. In a third phase 28, the exhaust-gas temperature upstream of particulate filter 16 is maintained at a high level of 600° C., by way of example, and the particulate filter is regenerated. After the third phase 28, the normal operation is taken up again and first temperature characteristic curve 22 falls. In a particulate filter 16 operating as designed, a third temperature characteristic curve 24 results downstream from particulate filter 16. In first phase 26, third temperature characteristic curve 24 is somewhat lower than first temperature characteristic curve 22. In second phase 27, third temperature characteristic curve 24 rises in a somewhat delayed fashion following first temperature characteristic curve 22. In third phase 28, soot is burnt off in particulate filter 16 in an exothermic reaction such that third temperature characteristic curve 24 rises higher than first temperature characteristic curve 22. Once the soot particulates stored in particulate filter 16 have been burnt off, third temperature characteristic curve 24 falls again. This temporary superelevation of third temperature characteristic curve 24 compared to first temperature characteristic curve 22 in third phase 28 is used as an indicator of a correctly operating particulate filter 16 in the monitoring. If the regeneration does not proceed as provided, a second temperature characteristic curve 23 arises downstream from particulate filter 16. In second phase 27, second and third temperature characteristic curves 23, 24 rise together. In third phase 28, second temperature characteristic curve 23, however, displays no superelevation compared to first temperature characteristic curve 22. The exothermic reaction typical for a regeneration is accordingly not occurring.

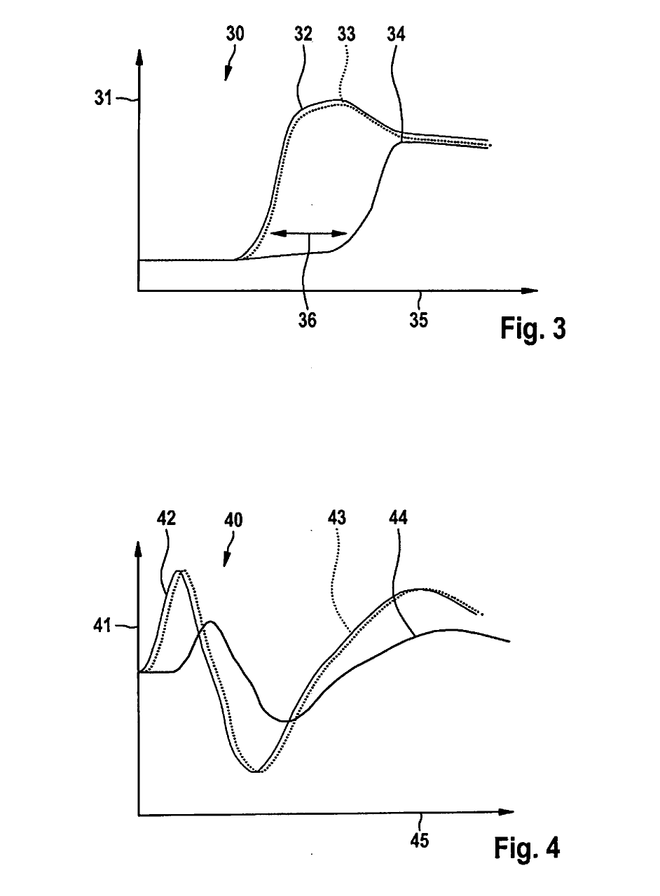

In a second temperature diagram 30, FIG. 3 shows temperature characteristic curves upstream and downstream from particulate filter 16 following a cold start of internal combustion engine 10. The temperatures are plotted along a second temperature axis 31 and a second time axis 35. A fourth temperature characteristic curve 32 shows the time characteristic of the temperature upstream of particulate filter 16. Initially, the gas mixture in the exhaust duct is approximately at ambient temperature. Following the start of internal combustion engine 10, fourth temperature characteristic curve 32 rises and adjusts to the operating temperature upon exceeding a maximum value. A sixth temperature characteristic curve 34 shows the temperature downstream from an intact particulate filter 16. Sixth temperature characteristic curve 34 rises to the operating temperature only after a delay time 36 resulting from the thermal mass of particulate filter 16. If particulate filter 16 is removed from exhaust duct 14, this delay time 36 is missing, and a fifth temperature characteristic curve 33 sets in, which follows the fourth temperature characteristic curve 32 in rise and elevation with only a small delay. For the monitoring, this behavior in a cold start is a clear indication of the existence of an error condition.

In a third temperature diagram 40, FIG. 4 shows temperature characteristic curves upstream and downstream from particulate filter 16 under varying operating conditions of internal combustion engine 10. Due to the changing operating conditions, a seventh temperature characteristic curve 42 shows temperature fluctuations upstream of particulate filter 16. In an intact particulate filter 16 present in exhaust duct 14, a ninth temperature characteristic curve 44 follows downstream from particulate filter 16 with a characteristic delay and, due to the heat capacity of particulate filter 16, has a lower amplitude of the temperature fluctuations than seventh temperature characteristic curve 42 upstream of particulate filter 16. If particulate filter 16 is removed from exhaust duct 14, this characteristic delay time and the reduction of the amplitude are absent, and an eighth temperature characteristic curve 43 sets in, which follows the seventh temperature characteristic curve 42 in rise and elevation with only a small delay. For the monitoring, this behavior under varying operating conditions of internal combustion engine 10 is a clear indication of the existence of an error condition.

All in all, by analyzing the elevation and characteristic curve of the temperatures upstream and downstream from the particulate filter, it is possible to infer in accordance with the present invention its correct regeneration. Furthermore, it is possible to detect a removal of the particulate filter and its replacement with a connecting pipe.

1-7. (canceled)

8. A method for monitoring a particulate filter in an exhaust duct of an internal combustion engine operated with gasoline, the method comprising:
determining a first exhaust-gas temperature upstream of the particulate filter;
determining a second exhaust-gas temperature downstream from the particulate filter; and
inferring a presence or correct functioning of the particulate filter from one of:
i) a difference between the first and the second exhaust-gas temperature, or ii) a differing time characteristic curve of the first and the second exhaust-gas temperature.

9. The method as recited in claim 8, wherein the first exhaust-gas temperature is modeled from operating parameters of the internal combustion engine and the second exhaust-gas temperature is determined using a second temperature sensor or an exhaust-gas sensor having a temperature function.

10. The method as recited in claim 8, wherein a correctly installed or functioning particulate filter is inferred during a regeneration of the particulate filter if the first exhaust-gas temperature in a specifiable period of time is lower than the second exhaust-gas temperature.

11. The method as recited in claim 8, wherein a correctly installed particulate filter is inferred if the time characteristic curve of the second exhaust-gas temperature has a greater than a first specified time delay with respect to the time characteristic curve of the first exhaust-gas temperature.

12. The method as recited in claim 8, wherein a correctly installed particulate filter is inferred if, following a cold start of the internal combustion engine, the time characteristic curve of the second exhaust-gas temperature has a greater than a first specified time delay with respect to the time characteristic curve of the first exhaust-gas temperature.

13. The method according to claim 8, wherein a correctly installed particulate filter is inferred if the time characteristic curve of the second exhaust-gas temperature has an amplitude that is smaller at most by a specifiable factor than the time characteristic curve of the first exhaust-gas temperature.

14. A device for monitoring a particulate filter in an exhaust duct of an internal combustion engine operated with gasoline, the device comprising:
a control unit assigned to the internal combustion engine;
a second temperature sensor situated in the exhaust duct downstream from the particulate filter; and
a circuit or a program sequence in the control unit to determine a first exhaust-gas temperature upstream of the particulate filter, detect a second temperature using the second temperature sensor, and monitor the particulate filter by an evaluation of at least one of an elevation and a time characteristic curve of the first and the second exhaust-gas temperature.
